(19) United States
(12) Patent Application Publication
(10) Pub. No.: US 2009/0101116 A1
(43) Pub. Date: Apr. 23, 2009

(54) FUEL PUMP

(76) Inventor: Eberhard Geissel, Kunzell (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/719,343

(22) PCT Filed: Oct. 5, 2005
(86) PCT No.: PCT/EP2005/055000

§ 371 Date: May 15, 2007

(30) Foreign Application Priority Data
Nov. 17, 2004 (DE) 10 2004 055 441.2

(51) Int. Cl. F02M 37/08; F04B 17/03; H02K 5/14; H02K 13/00

(52) U.S. Cl. 123/497; 417/423.7; 310/89

(57) ABSTRACT

A fuel pump has a pump stage (2) driven by an electric motor (1). Brushes (17) for contacting a commutator (16) are radially arranged next to a rotor (6). To this end, a stator (4) encircling the rotor (6) has pockets for accommodating these brushes (17). Connecting contacts (20) electrically connected to the brushes (17) are radially arranged next to the commutator (16). The fuel pump has a particularly small overall height.

### CROSS-REFERENCE TO RELATED APPLICATIONS

This application is a U.S. national stage application of International Application No. PCT/EP2005/055000 filed Oct. 5, 2005, which designates the United States of America, and claims priority to German application number 10 2004 055 441.2 filed Nov. 17, 2004, the contents of which are hereby incorporated by reference in their entirety.

### TECHNICAL FIELD

The invention relates to a fuel pump for conveying fuel from a fuel container of a motor vehicle.

### BACKGROUND

Such a fuel pump may have a pump stage which is driven by an electric motor, a shaft which is rotatably mounted and retains an impeller of the pump stage, a rotor of the electric motor, which rotor is arranged on the shaft in a rotationally fixed manner, and a stator, which is arranged radially outside the rotor, and brushes, which are prestressed against a commutator parallel to the shaft, for making contact with at least one coil which is arranged on the rotor.

Fuel pumps of this type are frequently used in modern motor vehicles and are known from practice. In general, two brushes of the electric motor are prestressed against the commutator in a perpendicular fashion. For the purpose of guiding the brushes, the electric motor has axial guides on that side of the commutator which is averted from the rotor. These axial guides are usually produced from an electrically conductive material and electrically connected to connection contacts which are arranged on a connection piece which covers the fuel pump. Known fuel pumps are therefore substantially composed of three sections which are arranged axially one above the other, specifically the pump stage, the section of the electric motor which comprises the stator and the rotor, and the connection piece for the electric motor.

One disadvantage of known fuel pumps is that they have a very large overall height. However, this is disadvantageous in modern fuel containers, which usually have an only very low overall height, since known fuel pumps cannot be fitted in fuel containers of this type.

### SUMMARY

A fuel pump can be designed in such a way that it has a particularly low overall height.

According to an embodiment, this problem is solved in that the brushes are arranged radially next to the coil of the rotor. In particular, according to an embodiment, a fuel pump for conveying fuel from a fuel container of a motor vehicle may comprise a pump stage which is driven by an electric motor, a shaft which is rotatably mounted and retains an impeller of the pump stage, a rotor of the electric motor, which rotor is arranged on the shaft in a rotationally fixed manner, and a stator, which is arranged radially outside the rotor, and having brushes, which are prestressed against a commutator parallel to the shaft, for making contact with at least one coil which is arranged on the rotor, wherein the brushes are arranged radially next to the coil of the rotor.

### BRIEF DESCRIPTION OF THE DRAWINGS

The invention permits numerous embodiments. In order to further explain the basic principle of said invention, several embodiments are described in the text which follows and illustrated in the drawing, in which

FIG. 1 schematically shows a longitudinal section through a fuel pump according to an embodiment,

FIG. 2 schematically shows a partial section through the fuel pump according to an embodiment from FIG. 1 along line II-II,

FIG. 3 schematically shows a partial section through a further embodiment of the fuel pump , and

FIG. 4 schematically shows a partial section through a further embodiment of the fuel pump.

### DETAILED DESCRIPTION

By virtue of this design, the length of the fuel pump according to an embodiment is substantially defined by the length of the rotor of the electric motor together with its bearing means and by the pump stage. In contrast to known fuel pumps, the brushes do not lead to an increase in the overall height since they are arranged next to the rotor and therefore level with the rotor. As a result, the fuel pump according to an embodiment has a particularly low overall height.

The brushes could, for example, be prestressed radially against a barrel-like commutator. However, this leads to the electric motor having large radial dimensions. However, the fuel pump according to an embodiment is of particularly compact design if the commutator is of disk-like design and, with its outer edge, extends beyond the stator, and if the brushes are arranged in the stator. By virtue of his design, the radial dimensions, in addition to the axial dimensions, of the electric motor are additionally also kept particularly low.

The fuel pump according to an embodiment is of particularly simple structural design if the brushes are arranged in a pocket in the stator.

According to another embodiment, the functioning of the stator can be prevented from being impaired by the arrangement of the brushes in a simple manner if the brushes are arranged in a gap between two adjacent magnetic shells of the stator. Since a gap of this type is usually present between adjacent magnetic shells in any case, a reduction in the size of the magnetic shells and therefore impairment of the functioning of the stator are largely avoided by arranging the brushes in the gap.

A contribution is made to further reducing the axial dimensions of the fuel pump according to an embodiment if connection contacts of the electric motor which are provided to connect the brushes to a power supply system are arranged radially next to the commutator or the stator.

Mounting of the fuel pump according to an embodiment is particularly simple if spring elements for prestressing the brushes against the commutator are arranged behind the brushes, as seen from the commutator. In this case, the spring elements are preferably each in the form of compression springs. By virtue of this design, the components of the fuel pump can be axially mounted in a simple manner.

A contribution is made to further simplifying mounting of the fuel pump according to an embodiment if magnetic shells of the stator or supports which are arranged between two magnetic shells support the spring elements for prestressing the brushes.

According to another embodiment, the space required by the brushes in the region of the stator can be kept particularly low if the spring elements surround the commutator and the brushes. The commutator and the brushes are preferably surrounded radially on the outside, as seen from the rotor. As a result, the prestressing means of the brushes has a particularly low installation space in the region of the stator. In the simplest case, the spring elements are of C-shaped design as seen in a side view.

In known fuel pumps, a housing cover which covers the electric motor is generally at a large distance from the commutator. According to another embodiment, a distance such as this can be avoided in a simple manner if a housing cover which has a bearing means for the shaft is positioned directly opposite the commutator.

A contribution is made to further simplifying the structural design of the fuel pump according to an embodiment if guides for the brushes are arranged parallel to the shaft.

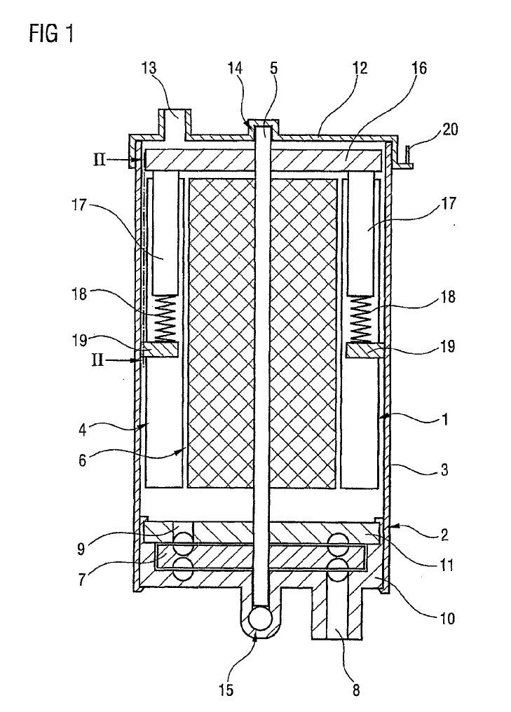

FIG. 1 shows a fuel pump with a pump stage 2 which is driven by an electric motor 1. The electric motor 1 has a stator 4 which is fixed in a housing 3 and a rotor 6 which is arranged on a shaft 5 in a rotationally fixed manner. The pump stage 2 has an impeller 7 which is arranged on the shaft 5 in a rotationally fixed manner. The impeller 7 rotates between two housing parts 10, 11 which have an inlet 8 and an outlet 9. The housing 3 of the fuel pump 2 is connected to the housing part 10, which has the inlet 8, of the pump stage 2 and to a housing cover 12 which covers the electric motor 1. The housing cover 12 has an outlet connection piece 13 and a bearing means 14 for one end of the shaft 5. The other end of the shaft 5 has a bearing means 15 in the housing part 10, which has the inlet 8, of the pump stage 2. The pump stage 2 is in the form of a widely known side channel pump. When the electric motor 1 is driven, the pump stage 2 conveys fuel from the inlet 8, through the outlet 9 and the electric motor 1, to the outlet connection piece 13. A feed line which is used to convey the fuel from a fuel container to an internal combustion engine can be connected to the outlet connection piece 13. The fuel container, the internal combustion engine and the feed line are not illustrated for the purpose of simplifying the drawing.

The electric motor 1 has a commutator 16 which is fixed to the shaft 5 and against which two brushes 17 are prestressed. The commutator 16 is of disk-like design and, with its outer edge, is extended beyond the stator 4 in which the brushes 17 are arranged in a displaceable manner. The brushes 17 are, for example, in the form of carbon pins and are prestressed by spring elements 18. The spring elements 18 are supported against a support 19 which is fixed in the housing 3. The commutator 16 is electrically connected to coils (not illustrated) of the rotor 6. Electrical power is supplied to the brushes 17 by means of connection contacts 20 which are arranged on the housing cover 12. The connection contacts 20 are arranged radially next to the commutator 16 and therefore have no influence on the overall axial height of the fuel pump.

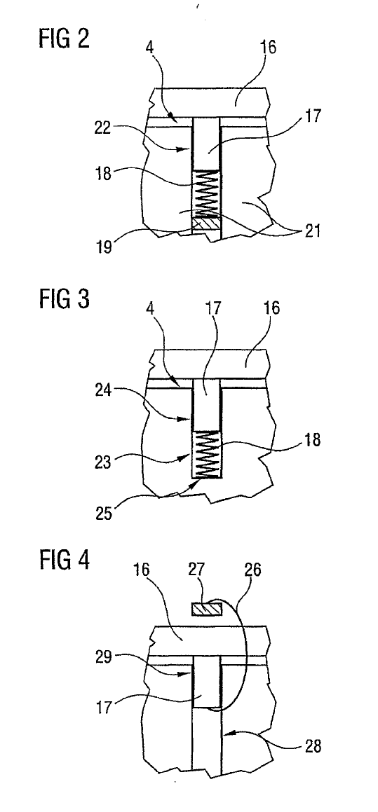

FIG. 2 shows a sectional illustration through the fuel pump from FIG. 1 along line II-II in the region of one of the brushes 17. It can be seen here that the brush 17 is guided in a gap between two magnetic shells 21 of the stator 4. The edges of the magnetic shells 21 therefore form a guide 22 for the brush 17.

FIG. 3 shows, from the perspective illustrated in FIG. 2, a further embodiment of the fuel pump, in which the stator 4 has a pocket 23 for accommodation purposes and as a guide 24 for the brush 17. The bottom of the pocket 23 forms a support 25 for supporting the spring element 18.

FIG. 4 shows a further embodiment of the fuel pump, in which the commutator 16 is surrounded by C-shaped spring element 26. One end of the spring element 26 prestresses the brush 17 against the commutator 16, whereas the other end is supported against a support 27 of the housing 3 which is illustrated in FIG. 1. The spring element 26 is illustrated such that it is rotated into the plane of the drawing in order to simplify the drawing. The stator 4 has a recess 28 as a guide for the brush 17 in this embodiment too.

What is claimed is:

1. A fuel pump for conveying fuel from a fuel container of a motor vehicle, comprising:
a pump stage which is driven by an electric motor,
a shaft which is rotatably mounted and retains an impeller of the pump stage,
a rotor of the electric motor, which rotor is arranged on the shaft in a rotationally fixed manner, and
a stator, which is arranged radially outside the rotor, and having brushes, which are prestressed against a commutator parallel to the shaft, for making contact with at least one coil which is arranged on the rotor, wherein the brushes are arranged radially next to the coil of the rotor.

2. The fuel pump according to claim 1, wherein the commutator is of disk-like design and, with its outer edge, extends beyond the stator, and wherein the brushes are arranged in the stator.

3. The fuel pump according to claim 1, wherein the brushes are arranged in a pocket in the stator.

4. The fuel pump according to claim 1, wherein the brushes are each arranged in a gap between two adjacent magnetic shells of the stator.

5. The fuel pump according to claim 1, wherein connection contacts of the electric motor which are provided to connect the brushes to a power supply system are arranged radially next to the commutator or the stator.

6. The fuel pump according to claim 1, wherein spring elements for prestressing the brushes against the commutator are arranged behind the brushes, as seen from the commutator.

7. The fuel pump according to claim 1, wherein magnetic shells of the stator or supports which are arranged between two magnetic shells support the spring elements for prestressing the brushes.

8. The fuel pump according to claim 1, wherein the spring elements surround the commutator and the brushes.

9. The fuel pump according to claim 1, wherein a housing cover which has a bearing means for the shaft is positioned directly opposite the commutator.

10. The fuel pump according to claim 1, wherein guides for the brushes are arranged parallel to the shaft.

11. A fuel pump for conveying fuel from a fuel container of a motor vehicle, comprising:
a pump stage driven by an electric motor,
a rotatably mounted shaft,
an impeller of the pump stage arranged on said shaft,
a rotor of the electric motor arranged on the shaft in a rotationally fixed manner, and
a stator arranged radially outside the rotor, and comprising brushes arranged radially next to the coil of the rotor and prestressed against a commutator parallel to the shaft, wherein the brushes contact at least one coil arranged on the rotor.

12. The fuel pump according to claim 11, wherein the commutator is of disk-like design and, with its outer edge, extends beyond the stator, and wherein the brushes are arranged in the stator.

13. The fuel pump according to claim 11, wherein the brushes are arranged in a pocket in the stator.

14. The fuel pump according to claim 11, wherein the brushes are each arranged in a gap between two adjacent magnetic shells of the stator.

15. The fuel pump according to claim 11, wherein connection contacts of the electric motor which are provided to connect the brushes to a power supply system are arranged radially next to the commutator or the stator.

16. The fuel pump according to claim 11, wherein spring elements for prestressing the brushes against the commutator are arranged behind the brushes, as seen from the commutator.

17. The fuel pump according to claim 11, wherein magnetic shells of the stator or supports which are arranged between two magnetic shells support the spring elements for prestressing the brushes.

18. The fuel pump according to claim 11, wherein the spring elements surround the commutator and the brushes.

19. The fuel pump according to claim 11, wherein a housing cover which has a bearing means for the shaft is positioned directly opposite the commutator.

20. The fuel pump according to claim 11, wherein guides for the brushes are arranged parallel to the shaft.
